(19) United States
(12) Patent Application Publication
(10) Pub. No.: US 2007/0220786 A1
(43) Pub. Date: Sep. 27, 2007

(54) Support system for a card and method of forming same

(76) Inventors: T. Kevin Vick, Thomasville, GA (US); Douglas M. Vick, Boston, GA (US)

Correspondence Address: JONES DAY, 77 WEST WACKER, CHICAGO, IL, 60601-1692, US

(21) Appl. No.: 11/369,721

(22) Filed: Mar. 7, 2006

(51) Int. Cl. G09F 1/00

(52) U.S. Cl. 40/124.01

(57) ABSTRACT

A support system for a greeting or place card. The card may include two integral panels and a brace formed from one of the panels, the brace being constructed to be partially separated along a perforated or cut edge or edges and bent so as to extend from one panel to the other panel. A slit may be formed in the brace to receive an edge of a panel and/or a slit may also be formed in one of the panels. An alternative card is formed with a brace that is totally separated from a panel, the panels each including a slit to receive an edge of the brace. The brace may also have a pair of slits to align and be received by the panel slits. In another embodiment, the brace is V-shaped and formed of material having a memory such that when fastened to a card, the brace places the card in a stable stance.

### CROSS REFERENCE TO PRIORITY APPLICATION

Not applicable.

### STATEMENT REGARDING FEDERALLY SPONSORED RESEARCH

Not applicable.

### BACKGROUND OF THE INVENTION

1. Field of the Invention

The present invention relates to a support system for a paper card and the method for forming the support, and more particularly, to a simple, elegant and inexpensive support system that may include a brace formed from the paper card or may include a separate and attachable brace.

2. Description of the Related Art

Paper cards in the form of greeting cards are often displayed in a partly opened or “A-frame” position on a mantle or shelf, especially at holiday time. Other paper cards, such as place cards frequently used at weddings and parties, are intended to be placed on tables in a partly opened position to indicate seating arrangements. Usually, such cards are supposed to be self-supporting, that is, the cards support themselves, but they tend not to be very stable. Many people have experienced the problem of walking past such cards, creating a disturbance of surrounding air, and watching the cards fall over. At other times the cards may sag under their own weight.

Cards of heavier weight paper tend to be somewhat more stable and less likely to be disturbed by movement of air. However, as noted, heavy weight cards tend to sag under their own weight and heavy paper is relatively expensive.

### BRIEF SUMMARY OF THE INVENTION

The difficulties encountered with greeting and place cards have been overcome by the present invention. What is described here is a self-supporting paper card apparatus including a paper card having two integrally connected panels, and a brace formed from one of the panels, the brace having a first side formed by cutting the panel from which the brace is formed.

In addition to increased stability, there are a number of other advantages achieved with the present invention. For example, the card structure is very simple, elegant and inexpensive. Another advantage is that the card structure is easy and quick to construct.

The invention here also includes methods for forming the support system for a displayed paper card.

A complete understanding of the present invention and other objects, advantages and features thereof will be gained from a consideration of the present specification, which provides a written description of the invention, and of the manner and process of making and using the invention, set forth in such full, clear, concise, and exact terms as to enable any person skilled in the art to which it pertains, or with which it is most nearly connected, to make and use the same in compliance with Title 35 U.S.C. section 112 (first paragraph). Furthermore, the following description of preferred embodiments of the invention read in conjunction with the accompanying drawing provided herein represents examples of the invention in compliance with Title 35 U.S.C. section 112 (first paragraph), but the invention itself is defined in the Claims section attached hereto.

### BRIEF DESCRIPTION OF THE DRAWINGS

FIG. 1 is an isometric view of a paper card showing an embodiment of the invention.

FIG. 2 is an isometric view of the paper card of FIG. 1 on a display surface showing a brace in an operative position.

FIG. 3 is an isometric view of a paper card illustrating another embodiment of the invention.

FIG. 4 is a partial isometric view of the paper card of FIG. 3 with the brace in an operative position.

FIG. 5 is an isometric view of a paper card illustrating still another embodiment of the present invention.

FIG. 6 is a partial isometric view of the paper card shown in FIG. 5 with a brace in an operative position.

FIG. 7 is a partial isometric view of a paper card illustrating yet another embodiment of the present invention.

FIG. 8 is a partial isometric view of the paper card shown in FIG. 7 with a brace in an operative position.

FIG. 9 is a partial isometric view of a paper card illustrating a further embodiment of the present invention.

FIG. 10 is a partial isometric view of the paper card of FIG. 9 with a brace in an operative position.

FIG. 11 is a partial isometric view of a paper card illustrating yet a further embodiment of the present invention.

FIG. 12 is a partial isometric view of the paper card of FIG. 11 illustrating a brace in an operative position.

FIG. 13 is a partial isometric view of a paper card illustrating a seventh embodiment of the present invention.

FIG. 14 is a partial isometric view of the paper card of FIG. 13 illustrating braces in operative positions.

FIG. 15 is a partial isometric view of a paper card illustrating an eighth embodiment of the present invention.

FIG. 16 is a partial isometric view of the paper card of FIG. 15 with braces in operative positions.

FIG. 17 is an isometric view of a paper card illustrating a ninth embodiment of the present invention.

FIG. 18 is an isometric view of the paper card of FIG. 17 showing a brace in an operative position.

FIG. 19 is an isometric view of a paper card illustrating a tenth embodiment of the present invention.

FIG. 20 is an isometric view of the paper card of FIG. 19 showing a brace in an operative position.

FIG. 21 is an isometric view of a paper card illustrating an eleventh embodiment of the present invention.

FIG. 22 is an isometric view of the paper card of FIG. 21 with a brace in an operative position.

FIG. 23 is an isometric view of a paper card illustrating a twelfth embodiment of the present invention.

FIG. 24 is an isometric view of the paper card of FIG. 23 with a brace in an operative position.

FIG. 25 is an isometric view of a further embodiment of the present invention.

FIG. 26 is an isometric view of the paper card of FIG. 25 with a brace fully removed from the paper card.

FIG. 27 is an isometric view of the paper card and the brace of FIG. 26 showing the brace in an operative position.

FIG. 28 is an isometric view of the paper card similar to the cards of FIGS. 1-27.

FIG. 29 is an enlarged isometric view of another embodiment of a brace.

FIG. 30 is an isometric view of the brace of FIG. 29 attached to the card of FIG. 28 in an operative position.

### DETAILED DESCRIPTION OF PREFERRED EMBODIMENTS OF THE INVENTION

While the present invention is open to various modifications and alternative constructions, the preferred embodiments illustrating the best mode contemplated by the inventors of carrying out their invention are shown in the various figures of the drawing and will be described herein in detail, pursuant to Title 35 U.S.C. section 112 (first paragraph). It is understood, however, that there is no intention to limit the invention to the particular embodiments, forms or examples that are disclosed herein. To the contrary, the intention is to cover all modifications, equivalent structures and methods, and alternative constructions falling within the spirit and scope of the invention as defined in the appended Claims section attached hereto, pursuant to Title 35 U.S.C. section 112 (second paragraph).

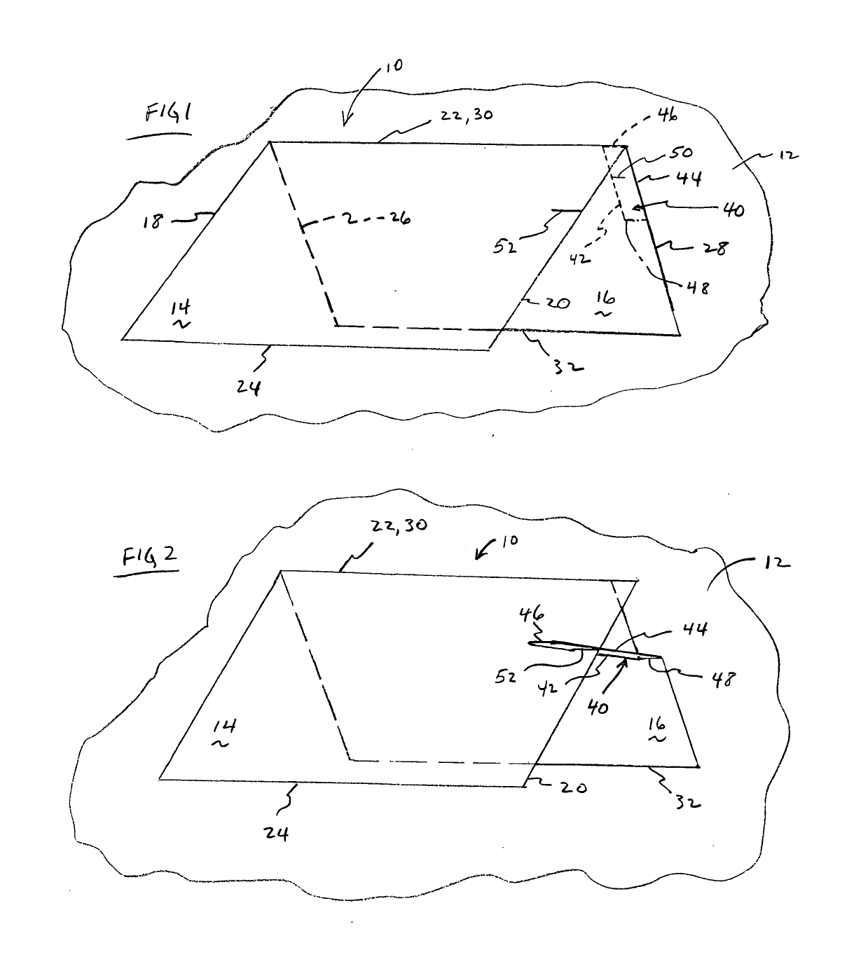

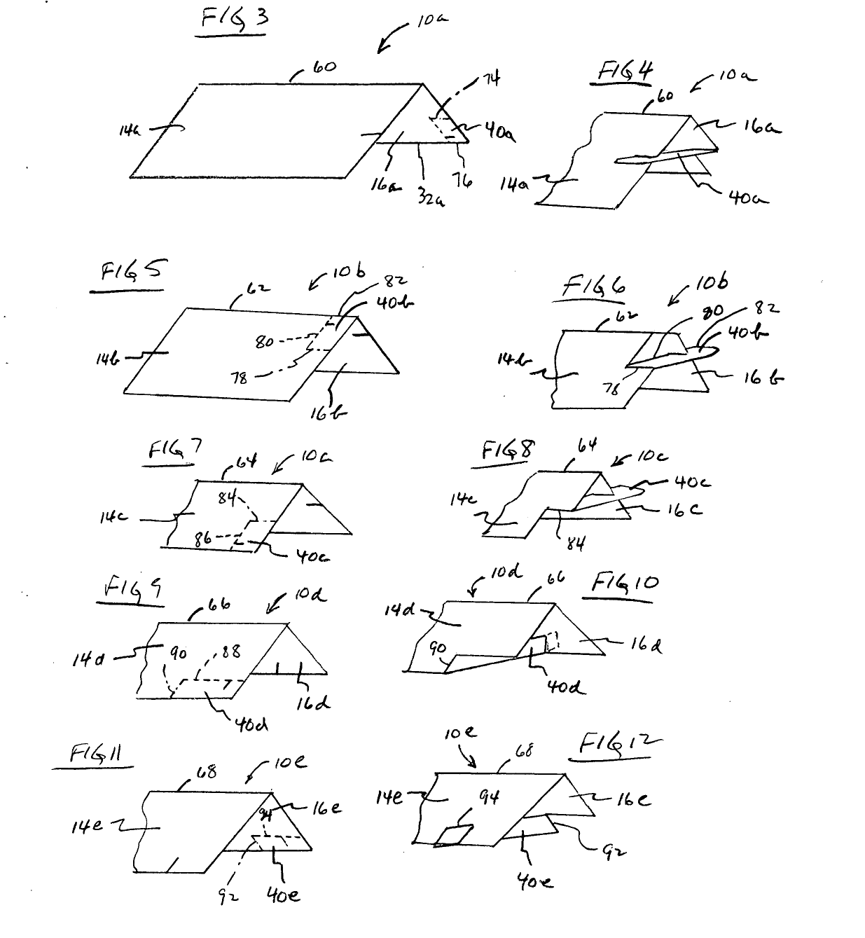

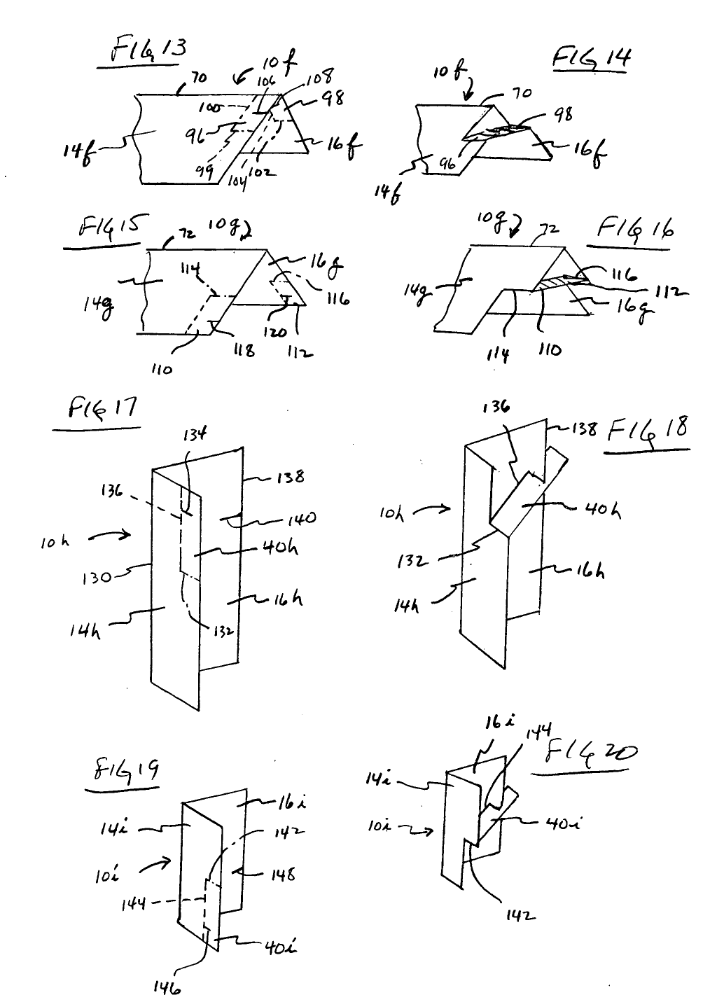

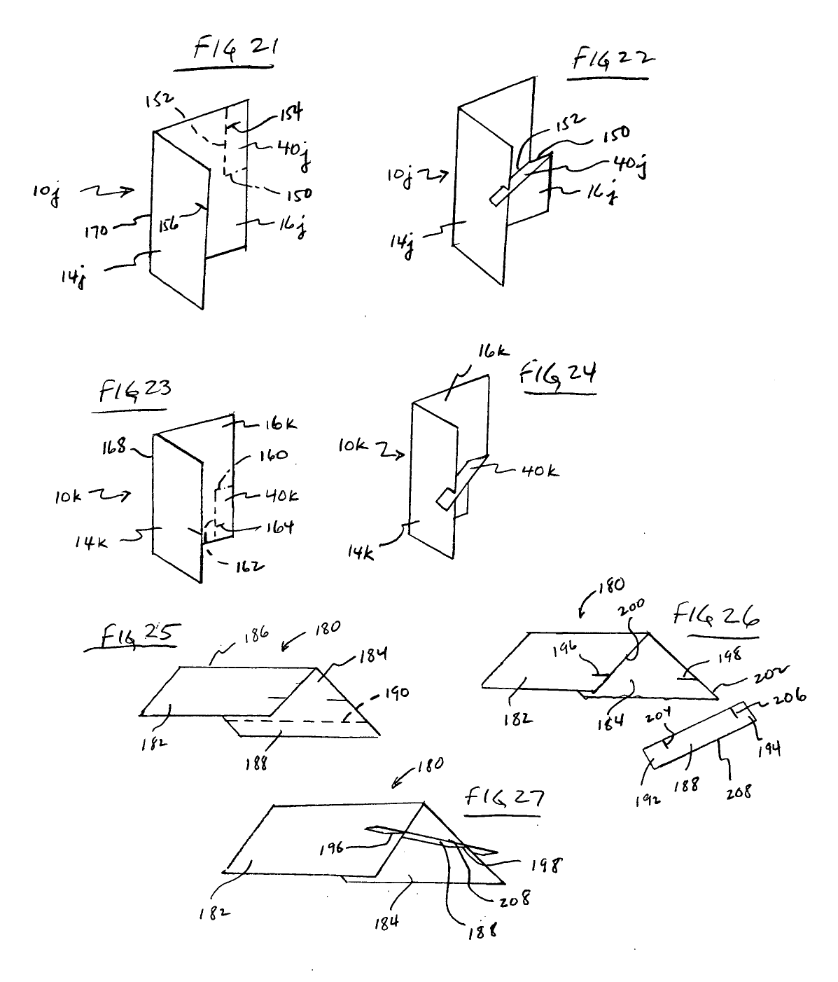

In FIGS. 1 and 2, there is illustrated one exemplary embodiment of the invention showing a paper card 10 in a sawhorse or A-frame stance on a display surface, such as a fireplace mantle 12. The card is formed of paper having a first or front panel 14 and a second or rear panel 16. The first panel includes two pairs of edges, namely, two side edges 18, 20 and top and bottom edges 22, 24. The second panel 16 also includes two pairs of edges, such as two side edges 26, 28 and top and bottom edges 30, 32. It may be seen that the top edges 22, 30 of the first panel 14 and the second panel 16 are coincident because the paper card 10 is formed of a single piece of paper that is folded in half to create the two panels 14, 16. Thus, the panels are integral with one another and the top edges 22, 30 are coincident.

A generally rectangular brace 40 is formed from the upper right hand portion of the rear panel 16. The brace 40 includes four edges including inner and outer side edges 42, 44 and upper and lower edges 46, 48. It is noted that the outer side edge 44 of the brace is coincident with and a portion of the side edge 28 of the rear panel 16 and that the upper edge 46 of the brace is coincident with and a portion of the top edge 30 of the rear panel. The brace inner side edge 42 and the brace upper edge 46 are formed by perforations or cuts and are intended to be separated from the remainder of the rear panel 16 by a recipient of a greeting card or a user of a place card. The lower edge 48 is formed by a fold or score line so as to easily allow the brace to be bent relative to the remainder of the rear panel 16 after the brace has been partly separated along the perforated or cut side and upper edges 42, 46. It is to be noted that perforations and cuts are depicted by short dotted lines or short solid lines in the figures and that fold lines are depicted by phantom lines. Hidden edges are depicted by long dotted lines.

The partially separated and bent or folded brace is shown in FIG. 2 where the brace 40 has been bent forward and engaged to the front panel 14. It is to be noted that the front panel may include a slit 52, which may be used to receive the brace 40 after it is separated and bent so that the outer side edge 44 of the brace defines a plane with the side edge 20 of the first panel. The brace 40 may also include a slit 50, so that the front panel side edge 20 is received by the slit 50 of the brace, or the slits of the panel and the brace may align and each receives the other to form an attachment. It is noted that the outer edge of the brace and the side edge of the panel may form a plane but they are not required to be so aligned.

The brace 40 shown in the embodiments of FIGS. 1-2 is connected at one end portion to one of the two card panels and at the opposite end portion to the other of the two card panels. The “one end portion” of the brace may be the brace portion adjacent the fold line 48 and the “opposite end portion” of the brace may be the brace portion surrounding the brace slit 50.

It can now be appreciated that the support systems disclosed in the embodiments shown in FIGS. 1-2 are simple, inexpensive and easy to manipulate and that the stability of the displayed greeting or place card is increased thereby.

The manufacture of a paper card, such as that shown in FIGS. 1 and 2, may also be easily accomplished. The paper card is formed from paper stock, and in greeting card format, may be printed on both sides so as to illustrate artwork on the front surface of the front panel 14, whereas a trademark, a bar code and other descriptive material may appear on the rear surface of the rear panel 16. It is noted that the front surface of the front panel and the rear surface of the rear panel are the same paper surface before the card is folded. Text may be printed on the front surface of the rear panel. It is noted that a place card may be devoid of print when manufactured.

Typically, the card 10 may be cut from the paper stock in a stamping operation using a die to create the side edges 18, 20, 26, 28 and the end edges, formerly described as bottom edges 24, 32. The same stamping die may also score the paper stock to facilitate bending of the card along the coincident edges 22, 30. At the same time the die may include a score bar to form a fold line coincident with the lower edge 48 of the brace 40, as well as sharp blades to form the perforations or cuts coincident with the side and upper edges 42, 46 of the brace 40. Furthermore, the die may include one or two cutting blades to form the slit 50 in the brace 40 and/or the slit 52 in the front panel 14. After the greeting card is printed, stamped, cut and scored, the card may be folded or bent along the coincident edges 22, 30 and then marketed.

An alternative to forming the brace at the time the card is manufactured is to have an apparatus that a card recipient may use. Such a hand held, hand operated apparatus is disclosed in co-pending Application No. ______, (Attorney Docket 694895-600002) entitled “Paper Card Brace Forming Apparatus,” filed on even date with the present application, which is incorporated herein by reference in its entirety. This co-pending application also discloses a die for simultaneously forming the brace during the manufacture of the card at the factory.

If the recipient of such a greeting card uses the hand held, hand operated apparatus, he/she removes the card from an envelope, reads the text and reviews the graphics and thereafter prepares to display the card. Display is simply accomplished by first opening the card so that it is generally extended or flat, whereupon the apparatus forms the brace from one of the panels and then he/she partially separates the brace from the panel by separating the paper along the perforation or cut, such as the side and upper edges 42 and 46, and thereafter by bending the brace along an edge, such as the lower edge 48 and by engaging the brace and the opposite card panel. If the brace includes a slit, such as the slit 50, the side edge 20 of the front panel is inserted into the slit. If only the front panel includes a slit, such as the slit 52, then the brace is inserted into the front panel 14 at the slit 52. If both the brace and the front panel include slits, then the brace and the front panel are engaged by having each received by the slit of the other to form a secure support.

When the card is braced, an A-frame is achieved where the two panels usually form an acute angle between themselves and the brace forms a truss or beam. The coincident edges 22, form the vertex of the angle. The card is sufficiently self-supporting on the bottom edges 24, 32 as shown in FIG. 2 to form a stable platform. The connected brace fixes the acute angle and prevents the panels from slipping away from each other and increasing the angle between them and also makes the card more difficult to tip over sideways.

In FIGS. 3-16, seven additional embodiments are illustrated. All of the cards 10a-10g include a front panel 14a-14g and an integral rear panel 16a-16g. The panels are connected along their top edges or fold lines 60, 62, 64, 66, 68, 70, 72 (only one number is used to label the fold line since the top edges of the two panels are coincident as described above in relation to the card embodiment of FIGS. 1 and 2). The fold lines 60, 62, 64, 66, 66, 68, 70, 72 extend generally horizontal to a display surface upon which the card rests, such as the mantle 12, FIG. 2. Each of the cards also includes a brace 40a-40e, FIGS. 3-12, however, the braces are arranged differently in each of the card embodiments. In the embodiment shown in FIGS. 3 and 4, for example, the brace 40a is folded along an upper edge 74, and a brace lower edge 76 is coincident with a card bottom edge 32a of the rear panel 16a. In its operative mode, the brace 40a is bent upwardly to extend and engage the front panel 14a. As with the embodiment in FIGS. 1 and 2, the panel and/or the brace may include a slit.

In the exemplary card embodiment shown in FIGS. 5 and 6, the brace 40b is integral with the front panel 14b. The brace is hinged along a lower fold line or edge 78 and has a perforated or cut side edge 80 and upper edge 82. When separated along the perforations or cuts and bent along the fold line, the brace extends from the front panel 14b to the rear panel 16b where it is engaged.

Another exemplary card embodiment shown in FIGS. 7 and 8 is similar to the embodiment of FIGS. 3 and 4 except that the brace 40c is integral with and formed from the front panel 14c. The brace 40c is folded along a top edge 84 and perforated along a side edge 86. The brace, when separated along the perforations or cuts and bent upwardly extends rearwardly to engage the rear panel 16c in the previously described fashion.

In the card embodiment shown in FIGS. 9 and 10, the brace 40d is formed horizontally at the bottom portion of the front panel 14d. The brace is perforated or cut along a top edge 88 and folded along a side edge 90. The brace 40d is hinged about a generally vertical axis so that it can be bent rearwardly and engage the rear panel 16d. It is noted that the brace embodiments of FIGS. 1-8 were all hinged about horizontal axes.

The card embodiment of FIGS. 11 and 12 is a reversal of the card embodiment of FIGS. 9 and 10 where the brace 40e is formed in the rear panel 16e and is hinged along a side edge 92 and perforated or cut along an upper edge 94. When separated and rotated, the brace 40e extends forwardly to engage the front panel 14e. It is noted that the panels and braces may have slits as previously described.

The exemplary card embodiment shown in FIGS. 13 and 14 differs from the already disclosed card embodiments in that two opposing braces 96 and 98 are formed. A front brace 96 is formed from the front panel 14f and is folded along a lower edge 99 and perforated or cut along a side edge 100. The rear brace 98 is formed from the rear panel 16f and is folded along a lower edge 102 and perforated or cut along a side edge 104. Each brace includes a slit 106, 108 and when separated and bent, the braces extend toward each other. The two braces 94 and 96 engage each other at the slits and form an interlocking embrace.

The card embodiment shown in FIGS. 15 and 16 also includes two braces 110 and 112. The brace 110 is integral with the front panel 14g and the brace 112 is integral with the rear panel 16g. The brace 110 is hinged along an upper edge 114 and the brace 112 is hinged along an upper edge 116. When separated and rotated toward each other, the braces receive each other in slits 118, 120 to cause an interlocking engagement.

In the card embodiments of FIGS. 13-16, the two braces act as one and the end portions may be considered the ends of the braces at their respective fold lines.

Each of the cards 10a-10g is constructed in a manner similar to that described for the card embodiment of FIGS. 1 and 2. When the card embodiments have the brace or braces at the lower portions of the integral panels, only one edge need be perforated or cut, whereas when the brace or braces are located at the upper portions of the integral panels, each brace has two perforated or cut edges.

In the card embodiments shown in FIGS. 1-16, the panels and/or the braces may include slits.

In FIGS. 17-24 four additional card embodiments are illustrated. Four paper cards 10h-10k, each having a front panel 14h-14k and a rear panel 16h-16k and a separable and foldable brace 40h-40k. The difference between the card embodiments shown in FIGS. 1-16 and those shown in FIGS. 17-24 is that the integral connections of the panels forming the central fold lines of the cards in FIGS. 17-24 are made vertically rather than horizontally. For example, the panels 14h and 16h, FIGS. 17-18, are integrally connected along a fold line 130. The brace 40h is hinged at a lower edge 132 where it remains attached to the front panel 14h and extends to the rear panel 16h where a slit 134 in a brace side edge 136 engages a side edge 138 of the rear panel 16h. The brace side edge 136 is perforated or cut and the rear panel may also include a slit 140.

In the card embodiment shown in FIGS. 19 and 20, the brace 401 extends from the front panel 141 to the rear panel 161. The brace 401 includes an upper edge fold line 142, a perforated or cut side edge 144 and a slit 146. The rear panel 161 may also include a slit 148.

The card embodiment of FIGS. 21 and 22 includes the brace 40j integral with the rear panel 16j and folded along a lower edge 150 and perforated or cut along a side edge 152. The brace may include a slit 154. The front panel 14j may also have a slit 156.

The card embodiment of FIGS. 23 and 24 has the brace 40k integral with the rear panel 16k, foldable along an upper edge 160 and perforated or cut along a side edge 162. The brace 40k may include a slit 164. The front panel 14k may also include a slit 166. The panels of the card embodiment of FIGS. 23 and 24 are integral at a vertical fold line 168. The panels of the card embodiment of FIGS. 21 and 22 are integral at a vertical fold line 170.

The method of manufacturing the paper cards 10h-10k is substantially similar to that already described hereinabove with regard to the card embodiment of FIGS. 1 and 2 except for the placement in the die of the perforation or cutting blades and score bars. The braces may also be formed by using the simple hand held device described in the above mentioned Application No ______.

Yet another card embodiment of the invention is shown in FIGS. 25-27 where there is a paper card 180 having a front panel 182 and a rear panel 184 integrally connected along a fold line 186 representing coincident top edges of the front and rear panels. There is also illustrated a brace 188, which is formed from the rear panel 184 and is defined by a horizontal line of perforations or a cut 90 at the lower portion of the rear panel. Instead of remaining attached to the rear panel as disclosed in relation to the card embodiments of FIGS. 1-24, the brace 188 may be completely severed and removed from the paper card 180 as shown in FIG. 26. Support of the card is achieved by having two opposing end portions 192, 194 of the brace engage slits 196, 198 formed in side edges 200, 202 of the front and rear panels 182, 184, respectively. The brace may also have a pair of slits 204, 206 to engage the slits 196, 198 of the front and rear panels 182, 184 to enable the brace to be positioned such that an edge 208 of the brace is flush with the side edges 200, 202 of the panels 182, 184.

A variation of the card/brace embodiment shown in FIGS. 25-27 has the brace formed separately. The brace may still be made of the same kind of paper used to make the card, or the brace may be made of thicker or thinner paper, a paper of a different color, or of a different material, such as a suitable plastic.

Still another card embodiment of an initially separate card and brace is illustrated in FIGS. 28-30. A typical greeting or place card 210 having panel side edges 212, 214 and a fold line 215 is illustrated in FIG. 28. A brace 216, shown enlarged in FIG. 29, may be made of paper or plastic that is folded once along a score or line 218 or extruded or otherwise formed to result in two panels 220, 222 that are generally parallel to each other and which may be biased toward one another. Thereafter, the brace may be folded again along a score or line 224 perpendicular to the score 218 to form a two-legged V-shape. The second fold forms two end portions or legs 226, 228 that diverge from the fold line 224 to form a right or an acute angle, which in one embodiment is about 40°. Choosing suitable material ensures that the brace material has a memory so as to maintain the shape shown in FIG. 29. The brace 216 may be formed by a manufacturer or by a recipient.

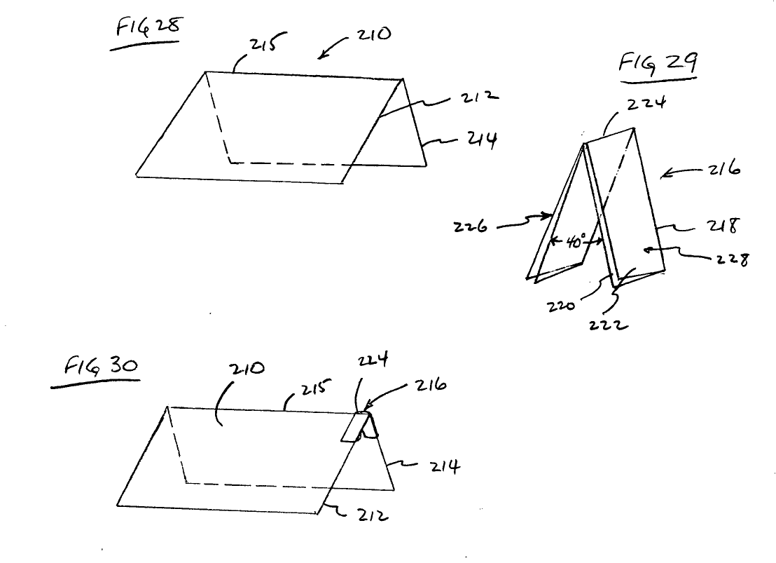

In operation, a recipient of the card inserts the card edges 212, 214 between the two brace panels 220, 222 such that the brace fold line 224 is parallel to the card fold line 215 as shown in FIG. 30. The memory and/or biasing force of the brace material maintains the brace on the card by friction and the angle of the brace legs causes the card panels to assume the same stance, FIG. 30, as the brace, resulting in a more stable position for the card.

It is noted that any suitable material may be used for the brace and the acute angle formed between the brace legs may also be any suitable angle. If desired, the angle formed between the legs may be even greater than 90°.

It can now be appreciated that the support systems disclosed and the methods of forming the system are very simple, elegant, inexpensive, easily manipulated and closely aligned with existing manufacturing practices and procedures.

The above specification describes a number of preferred embodiments of the present invention. Other examples, embodiments, modifications and variations will, under both the literal claim language and the doctrine of equivalents, come within the scope of the invention defined by the appended claims. For example, the paper card may have more than two integral panels or the panels may be formed separately and then adhered along an edge of each panel. In either case, a brace, either integral or separated, may be used to enhance stability of the displayed card. These are all considered equivalent structures and will also come within the literal language of the claims. Still other alternatives will also be equivalent as will many new technologies. There is no desire or intention here to limit in any way the application of the doctrine of equivalents nor to limit or restrict the scope of the invention as expressed by the following claims.

1. A self supporting paper card apparatus comprising:
a paper card having two integrally connected panels; and
a brace formed from one of the panels, the brace having a first side formed by perforating or cutting the panel from which the brace is formed wherein the first side of the brace is separated from the panel from which the brace is formed.

2. The apparatus as claimed in claim 1 wherein:
the brace includes a second side formed by folding the brace relative to the panel from which the brace is formed.

3. The apparatus as claimed in claim 2 wherein:
the brace includes a third side formed by cutting the panel from which the brace is formed, the third side being adjacent the first side and being separated from the panel from which the brace is formed.

4. The apparatus as claimed in claim 3 including:
a slit formed in the other panel which does not form the brace for receiving the brace.

5. The apparatus as claimed in claim 1 including:
a slit formed in the other panel which does not form the brace for receiving the brace.

6. The apparatus as claimed in claim 5 wherein:
the brace includes a second side formed by folding the brace relative to the panel from which the brace is formed.

7. The apparatus as claimed in claim 4 wherein:
the brace includes a slit for receiving the slit formed in the other panel.

8. The apparatus as claimed in claim 1 wherein:
the brace includes two spaced apart slits formed in the brace at right angles to the first side.

9. The apparatus as claimed in claim 8 wherein:
each panel includes a slit for receiving one of the slits formed in the brace.

10. The apparatus as claimed in claim 1 wherein:
the cutting of the panel along the first side of the brace enables separation of the brace completely from the panel from which the brace is formed; and
each panel includes a slit for receiving the separated brace.

11. A support apparatus to enable display of a paper card comprising:
a two legged V-shaped brace including two integrally formed, nearly parallel walls, each leg of the brace for receiving a side edge of one of a two panel paper card and the fold between the two panels.

12. The apparatus as claimed in claim 11 wherein:
the brace is formed of a thin sheet of plastic.

13. The apparatus as claimed in claim 11 wherein:
the legs of the V-shaped brace form an angle of ninety degrees or less.

14. The apparatus as claimed in claim 12 wherein:
the legs of the V-shaped brace form an angle of ninety degrees or less.

15. The apparatus as claimed in claim 13 wherein:
the brace is formed of paper.

16. A method for forming a support system for a displayed paper card comprising the steps of:
integrally connecting two panels of a paper card to enable said panels to extend away from the connection forming an acute angle between said panels; and
forming a brace having two end portions to connect at one of the end portions to one of said panels and at the other of the end portions to the other of said panels.

17. The method as claimed in claim 16 including the step of:
forming said brace integrally with one of said panels along a line of separation.

18. The method as claimed in claim 17 including the steps of:
forming said brace along a fold line to enable said brace to be separated from the connected panel along the line of separation and folded along the fold line to extend the brace to the other of said panels.

19. The method as claimed in claim 16 including the steps of:
forming the brace to have two integrally connected walls with a two-legged V-shape, each of the legs being an end portion; and
inserting each of said panels between the walls of a leg of said brace.

20. A method for forming a support system for a displayed paper card comprising the steps of:
integrally connecting two panels of a paper card;
forming a planar brace; and
slitting each of the two panels to receive the brace to enable the brace to extend from one panel to the other panel when the panels are positioned to form an acute angle.

21. The method as claimed in claim 20 including the step of:
forming a pair of slits in said brace to receive the slits of said panels.
